(19) United States
(12) Patent Application Publication
(10) Pub. No.: US 2022/0066468 A1
(43) Pub. Date: Mar. 3, 2022

(54) TRANSPORT SYSTEM, TRANSPORT METHOD, AND PROGRAM

(71) Applicant: Toyota Jidosha Kabushiki Kaisha, Toyota-shi Aichi-ken (JP)

(72) Inventors: Kunihiro Iwamoto, Nagakute-shi (JP); Yuta Itozawa, Nagoya-shi (JP); Hirotaka Komura, Anjo-shi (JP)

(73) Assignee: Toyota Jidosha Kabushiki Kaisha, Toyota-shi Aichi-ken (JP)

(21) Appl. No.: 17/411,246

(22) Filed: Aug. 25, 2021

(30) Foreign Application Priority Data
Aug. 27, 2020 (JP) 2020-143268

(51) Int. Cl. G05D 1/02; B66F 9/06; B66F 9/075; B60W 60/00; G06K 7/14

(52) U.S. Cl. CPC G05D 1/0276; B66F 9/063; B66F 9/0755; G06K 7/1417; G05D 1/0297; B60W 60/00256; G06K 7/1413; G05D 1/0212

(57) ABSTRACT

A transport system, a transport method, and a program capable of selecting an appropriate support position when a target object is supported and lifted by an autonomous mobile robot are provided. The transport system supports and transports a target object by an autonomous mobile robot, the transport system including: a marker position specifying unit configured to specify a position of a marker attached to a target object; and an operation controller configured to determine a support position of the target object based on the position of the marker that has been specified.

### CROSS REFERENCE TO RELATED APPLICATIONS

This application is based upon and claims the benefit of priority from Japanese patent application No. 2020-143268, filed on Aug. 27, 2020, the disclosure of which is incorporated herein in its entirety by reference.

### BACKGROUND

The present disclosure relates to a transport system, a transport method, and a program, and in particular, to transportation by an autonomous mobile robot.

In recent years, technologies for transporting objects by an autonomous mobile robot in a factory or a warehouse have been developed. For example, International Patent Publication No. WO 2017/090108 discloses a shelf arrangement system for automatically arranging shelves using a transport robot in a logistics warehouse. In this system, a transport robot enters a space under a shelf, lifts the shelf from below, and moves along with the shelf.

### SUMMARY

The system disclosed in International Patent Publication No. WO 2017/090108 is intended to transport shelves with uniform features. Therefore, a support position for lifting a shelf is constant. However, when, for example, it is required to transport various kinds of objects such as furniture in a house, the respective positions of the centers of gravity for these objects may vary. It is thus difficult for this system to select an appropriate support position when it lifts an object.

The present disclosure has been made in view of the aforementioned circumstances and aims to provide a transport system, a transport method, and a program capable of selecting an appropriate support position when the target object is supported and lifted by an autonomous mobile robot.

One aspect of the present disclosure to attain the aforementioned object is a transport system configured to support and transport a target object by an autonomous mobile robot, the transport system including: a reference object position specifying unit configured to specify a position of a reference object attached to the target object; and an operation controller configured to determine a support position of the target object based on the position of the reference object that has been specified.

According to the above transport system, the support position of the target object is determined based on the position of the reference object attached to the target object. Therefore, it is possible to select an appropriate support position when the target object is supported and lifted by the autonomous mobile robot.

In the above aspect, the reference object may be attached to a predetermined position of the target object in advance, the predetermined position may be a position to be supported specified in advance, and the operation controller may set the position of the reference object as the support position of the target object.

According to this structure, the position of the reference object may be set as the support position of the target object, whereby it is possible to easily specify the support position.

In the above aspect, the reference object may store information indicating a relative position of a predetermined position of the target object from the position of the reference object, the predetermined position may be a position to be supported specified in advance, the transport system may further include a reading unit configured to read out the information that indicates the relative position and is stored in the reference object, and the operation controller may specify the predetermined position of the target object based on the information indicating the relative position and sets the predetermined position as the support position of the target object.

According to this structure, the support position is determined based on the position of the reference object and the relative position obtained from the information stored in the reference object. Therefore, it is possible to not only select an appropriate support position when the target object is supported and lifted by the autonomous mobile robot but also attach a reference object to a desired position.

In the above aspect, the reference object may store operation related information, which is information used to control a moving operation or a supporting operation of the autonomous mobile robot, the transport system may further include a reading unit configured to read out the operation related information stored in the reference object, and the operation controller may control the moving operation or the supporting operation of the autonomous mobile robot using the operation related information.

According to this structure, the autonomous mobile robot is able to easily achieve an operation based on the operation related information.

In the above aspect, the reference object may store information indicating an ability of the autonomous mobile robot required to transport the target object, and the transport system may further include: a reading unit configured to read out the information that indicates the ability and is stored in the reference object; and a determination unit configured to determine whether or not to transport the target object based on the information indicating the ability.

According to the above structure, information indicating the ability of the autonomous mobile robot required to transport a target object is stored in the reference object, whereby it is possible to determine whether or not the autonomous mobile robot is able to support the target object. Therefore, it is possible to prevent an autonomous mobile robot whose ability is not high enough to support the target object from supporting this target object.

In the above aspect, the transport system may further include a notification unit configured to send a notification for asking an autonomous mobile robot having an ability specified by the information indicating the ability to transport the target object.

According to the above structure, a notification for requesting the autonomous mobile robot having the required ability to transport the target object is sent to this autonomous mobile robot. Accordingly, it is possible to achieve transportation by an appropriate autonomous mobile robot.

In the above aspect, the operation controller may further adjust the orientation of the autonomous mobile robot when supporting is started in such a way that an angle between a direction required for the target object at a transportation destination point and a traveling direction of the autonomous mobile robot at the time of final traveling to the transportation destination point becomes equal to an angle between a direction of the target object when the transportation is started and a forward traveling direction or a backward traveling direction of the autonomous mobile robot when the transportation is started.

According to this structure, it is possible to prevent the orientation of the autonomous mobile robot with respect to the target object from being adjusted in the middle of the transportation in such a way that the direction of the target object becomes appropriate at a transportation destination point. The efficiency of the transportation is therefore improved.

In the above aspect, the operation controller may further adjust the orientation of the autonomous mobile robot when the supporting is started in such a way that an angle between a direction that is required for the target object to pass a gap on a transport route and a traveling direction of the autonomous mobile robot when it passes the gap becomes equal to an angle between a direction of the target object when the transportation is started and a forward traveling direction or a backward traveling direction of the autonomous mobile robot when the transportation is started.

According to this structure, it is possible to prevent the orientation of the autonomous mobile robot with respect to the target object from being adjusted in the middle of the transportation in order to pass the gap. The efficiency of the transportation is therefore improved.

In the above aspect, the reference object may store information indicating the position of a predetermined part of the target object, the transport system may further include a reading unit configured to read out information that indicates the position of the predetermined part and is stored in the reference object, and the operation controller may specify the direction of the target object based on the information indicating the position of the predetermined part.

According to this structure, it is possible to easily specify the direction of the target object.

In the above aspect, when a movement of another autonomous mobile robot is planned, the operation controller may perform control so as to support a predetermined target object and move the target object away from a moving range of the other autonomous mobile robot before the movement of the other autonomous mobile robot is started.

According to this structure, the target object is moved to the outside of the moving range before the movement of the other autonomous mobile robot is started. Therefore, it is possible to prevent execution of the operation of the other autonomous mobile robot from being interrupted due to the presence of the target object.

In the above aspect, the autonomous mobile robot may include a supporting part including a fitting part that fits the target object, and the operation controller may perform control so as to support the target object by the supporting part.

According to this structure, it is possible to improve support stability.

In the above aspect, the target object may be a component that forms a piece of furniture by being combined with the supporting part.

According to this structure, the autonomous mobile robot may be used as furniture.

In the above aspect, the supporting part may be electrically connected to the target object.

According to this structure, it is possible to implement various functions that use electrical connection.

Another aspect of the present disclosure to attain the aforementioned object is a transport method for supporting and transporting a target object by an autonomous mobile robot, the transport method including: specifying a position of a reference object attached to the target object; and determining a support position of the target object based on the position of the reference object that has been specified.

According to this transport method, the support position of the target object is determined based on the position of the reference object attached to the target object. Therefore, it is possible to select an appropriate support position when the target object is supported and lifted by the autonomous mobile robot.

Another aspect of the present disclosure to attain the aforementioned object is a program for causing a computer of a transport system configured to support and transport a target object by an autonomous mobile robot to execute: specifying a position of a reference object attached to the target object; and determining a support position of the target object based on the position of the reference object that has been specified.

According to this program, the support position of the target object is determined based on the position of the reference object attached to the target object. Therefore, it is possible to select an appropriate support position when the target object is supported and lifted by the autonomous mobile robot.

According to the present disclosure, it is possible to provide a transport system, a transport method, and a program capable of selecting an appropriate support position when a target object is supported and lifted by an autonomous mobile robot.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective view showing a schematic configuration of an autonomous mobile robot according to an embodiment;

FIG. 2 is a side view showing a schematic configuration of the autonomous mobile robot according to the embodiment;

FIG. 3 is a block diagram showing a schematic system configuration of the autonomous mobile robot according to the embodiment;

FIG. 4 is a schematic view describing support of a target object by the autonomous mobile robot according to the embodiment;

FIG. 5 is a schematic view showing a marker attached to the target object;

FIG. 6 is a block diagram showing one example of a functional configuration of a control apparatus of an autonomous mobile robot according to a first embodiment;

FIG. 7 is a flowchart showing one example of a flow of processing of a transport operation by the autonomous mobile robot according to the first embodiment;

FIG. 8 is a block diagram showing one example of a functional configuration of a control apparatus of an autonomous mobile robot according to a second embodiment;

FIG. 9 is a flowchart showing one example of a flow of processing of a transport operation by the autonomous mobile robot according to the second embodiment;

FIG. 10 is a block diagram showing one example of a functional configuration of a control apparatus of an autonomous mobile robot according to a third embodiment;

FIG. 11 is a flowchart showing one example of a flow of processing of a transport operation by the autonomous mobile robot according to the third embodiment;

FIG. 12 is a block diagram showing one example of a functional configuration of a control apparatus of an autonomous mobile robot according to a fourth embodiment;

FIG. 13 is a plan view showing an example of an environment in which transportation is conducted;

FIG. 14 is a schematic view showing an orientation of the autonomous mobile robot with respect to a target object adjusted at a time of start of the transportation when the transportation as shown in FIG. 13 is conducted;

FIG. 15 is a plan view showing an example of an environment in which transportation is conducted;

FIG. 16 is a schematic view showing an orientation of the autonomous mobile robot with respect to a target object adjusted at a time of start of the transportation when the transportation as shown in FIG. 15 is conducted;

FIG. 17 is a plan view showing an example of the environment in which transportation is conducted;

FIG. 18 is a flowchart showing one example of a flow of processing of a transport operation by the autonomous mobile robot according to the fourth embodiment;

FIG. 19 is a schematic view showing one example of a configuration of a transport system according to a fifth embodiment;

FIG. 20 is a block diagram showing one example of a functional configuration of a control apparatus of an autonomous mobile robot according to the fifth embodiment; and

FIG. 21 is a flowchart showing one example of a flow of processing of a transport operation by the autonomous mobile robot according to the fifth embodiment.

### DESCRIPTION OF EMBODIMENTS

Hereinafter, with reference to the drawings, embodiments of the present disclosure will be described.

### First Embodiment

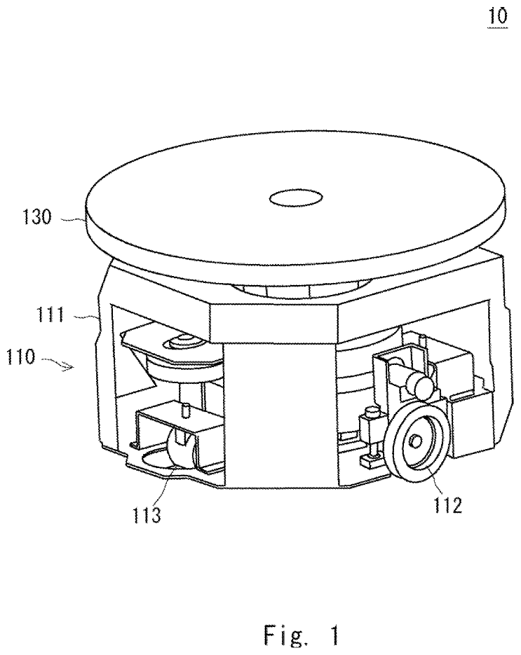

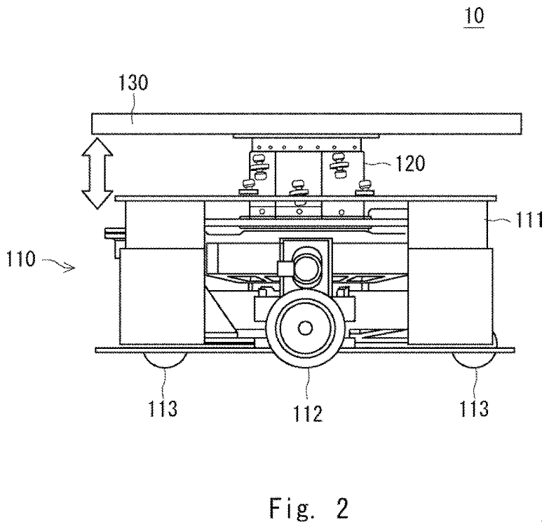

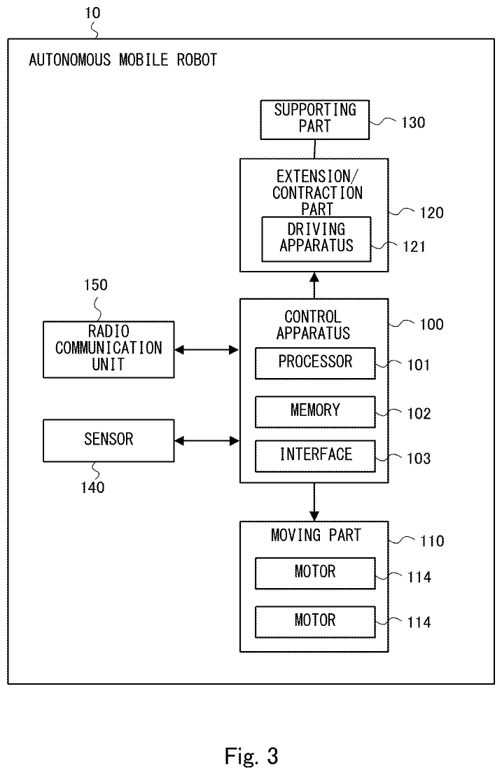

FIG. 1 is a perspective view showing a schematic configuration of an autonomous mobile robot 10 according to an embodiment. FIG. 2 is a side view showing a schematic configuration of the autonomous mobile robot 10 according to the embodiment. FIG. 3 is a block diagram showing a schematic system configuration of the autonomous mobile robot 10 according to the embodiment.

The autonomous mobile robot 10 according to the embodiment is, for example, a robot that autonomously moves in a movement environment such as a house, a facility, a warehouse, or a factory, and may belong to a transport system that supports and transports a target object by the autonomous mobile robot 10. The autonomous mobile robot 10 according to this embodiment includes a moving part 110 capable of moving, an extension/contraction part 120 that is extended and contracted in a vertical direction, a supporting part 130 for supporting a target object, a control apparatus 100 that performs control of the autonomous mobile robot 10 including control of the moving part 110 and the extension/contraction part 120, a sensor 140, and a radio communication unit 150.

The moving part 110 includes a robot body 111, a pair of right and left driving wheels 112 and a pair of front and rear trailing wheels 113 rotatably disposed in the robot body 111, and a pair of motors 114 that rotatably drive the respective driving wheels 112. The motors 114 rotate the respective driving wheels 112 via a decelerator or the like. The motors 114 rotate the respective driving wheels 112 in accordance with a control signal from the control apparatus 100, thereby enabling the robot body 111 to move forward or backward and rotate. Accordingly, the robot body 111 is able to move to a desired position. The configuration of the aforementioned moving part 110 is merely one example and is not limited to the above one. For example, the number of driving wheels 112 and trailing wheels 113 of the moving part 110 may be any number and the moving part 110 may have any structure as long as they can move the robot body 111 to a desired position.

The extension/contraction part 120 is an extension/contraction mechanism that is extended and is contracted in the vertical direction. The extension/contraction part 120 may be formed of a telescopic extension/contraction mechanism. The supporting part 130 is provided in the upper end of the extension/contraction part 120 and the supporting part 130 is raised or lowered by an operation of the extension/contraction part 120. The extension/contraction part 120 includes a driving apparatus 121 such as a motor and is extended and contracted by the drive of the driving apparatus 121. That is, the supporting part 130 is raised or lowered by the drive of the driving apparatus 121. The driving apparatus 121 drives in accordance with a control signal from the control apparatus 100. The autonomous mobile robot 10 may include, in place of the extension/contraction part 120, any known mechanism that controls the height of the supporting part 130 provided above the robot body 111.

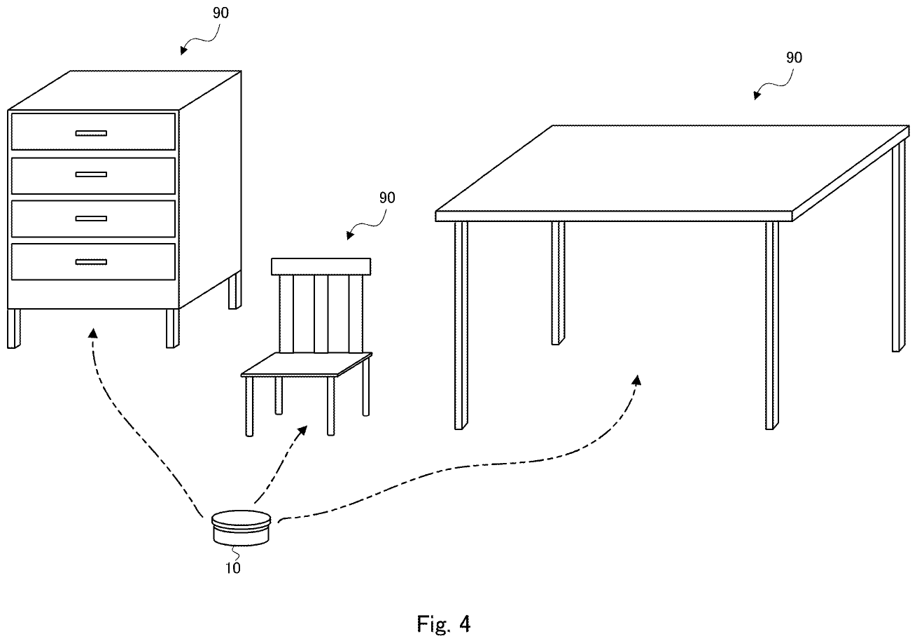

The supporting part 130 is provided above (top of) the extension/contraction part 120. The supporting part 130 is raised and lowered by the driving apparatus 121 such as the motor. In this embodiment, the supporting part 130 is used to support and lift a target object to be transported. The supporting part 130 is formed of, for example, a plate. While the shape of this plate, i.e., the shape of the supporting part 130, is, for example, a disc shape having a flat top surface in this embodiment, it may be any other desired shape. The autonomous mobile robot 10 supports and lifts the target object by this supporting part 130. The autonomous mobile robot 10 is thus able to transport the target object. For example, as shown in FIG. 4, the autonomous mobile robot 10 enters a space which is located under the target object 90 and lifts the target object 90 by the supporting part 130 from below. Then the autonomous mobile robot 10 moves along with the target object 90 while supporting the target object 90 by the supporting part 130. The autonomous mobile robot 10 thus transports the target object 90. While the target object 90 is, for example, furniture such as a chest of drawers, a chair, a table, or a shelf, this is merely an example. The target object 90 may be any other object.

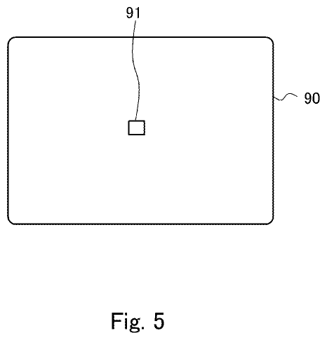

The sensor 140 is a sensor that is provided in a desired position of the autonomous mobile robot 10 and detects a marker 91 attached to the target object 90 (see FIG. 5). The sensor 140 may be, for example, a camera. When the marker 91 is formed using a material (e.g., ink) that absorbs or reflects infrared rays, the sensor 140 may be an infrared camera so as to be able to detect the marker. The output of the sensor 140 is input to the control apparatus 100.

In this embodiment, the marker 91 is attached to a predetermined position of the target object 90 in advance. The predetermined position is a position to be supported specified in advance. The predetermined position is, for example, a position of the target object 90 where it is balanced when it is lifted by the supporting part 130 of the autonomous mobile robot 10. Specifically, for example, the predetermined position is a position just below the center of gravity of the target object 90. Accordingly, in this embodiment, the marker 91 is attached, for example, to the position just below the center of gravity on a surface of a lower side of the target object 90. When, for example, the target object 90 is an object to be sold, the target object 90 to which the marker 91 is attached in advance may be sold. Further, a user of the target object 90 may attach the marker 91 in a predetermined position. In this embodiment, the marker 91 may include a predetermined mark that can be detected by the sensor 140. The marker 91 may be, for example, a sticker with a predetermined characteristic mark printed thereon. Further, the marker 91 may be a barcode or a two-dimensional code such as a QR code (registered trademark). Further, the marker 91 may be an invisible marker so as not to spoil the design of the target object 90. For example, the marker 91 may be an invisible marker printed with a material that absorbs or reflects infrared rays.

The radio communication unit 150, which is a circuit for performing radio communication in order to communicate with a server or another robot, includes, for example, a radio transmission/reception circuit and an antenna. When the autonomous mobile robot 10 does not communicate with other devices, the radio communication unit 150 may not be provided.

The control apparatus 100, which is an apparatus that controls the autonomous mobile robot 10, includes a processor 101, a memory 102, and an interface 103. The processor 101, the memory 102, and the interface 103 are connected to one another via a data bus or the like.

The interface 103 is an input/output circuit that is used to communicate with other apparatuses such as the moving part 110, the extension/contraction part 120, the sensor 140, and the radio communication unit 150.

The memory 102 is composed of, for example, a combination of a volatile memory and a non-volatile memory. The memory 102 is used to store software (computer program) that includes one or more instructions and is executed by the processor 101, data to be used for various kinds of processing of the autonomous mobile robot 10 and the like.

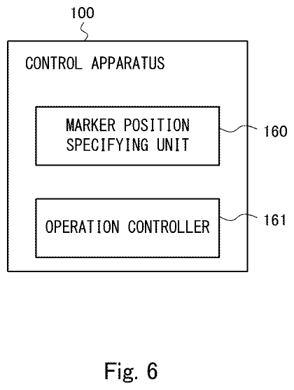

The processor 101 loads software (computer program) from the memory 102 and executes the loaded software (computer program), thereby performing processing of the respective components shown in FIG. 6 described later. Specifically, the processor 101 performs processing of a marker position specifying unit 160 and an operation controller 161.

The processor 101 may be, for example, a microprocessor, a Micro Processor Unit (MPU), a Central Processing Unit (CPU) or the like. The processor 101 may include a plurality of processors.

As described above, the control apparatus 100 is an apparatus that functions as a computer.

The aforementioned program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

FIG. 6 is a block diagram showing one example of a functional configuration of the control apparatus 100 of the autonomous mobile robot 10 according to the first embodiment. As shown in FIG. 6, the control apparatus 100 includes a marker position specifying unit 160 and an operation controller 161.

The marker position specifying unit 160 specifies a position of the marker 91 attached to the target object 90. The marker position specifying unit 160 analyzes output data from the sensor 140 and detects the marker 91, thereby specifying the position of the marker 91. For example, the marker position specifying unit 160 performs image recognition processing on image data output from the sensor 140, thereby detecting the marker 91 and specifying its position.

The operation controller 161 controls the moving operation and the supporting operation of the autonomous mobile robot 10. That is, the operation controller 161 controls the moving part 110 and the extension/contraction part 120. The operation controller 161 transmits a control signal to each of the motors 114 of the moving part 110, thereby controlling the rotation of each of the driving wheels 112 and moving the robot body 111 to a desired position. Further, the operation controller 161 is able to control the height of the supporting part 130 by transmitting a control signal to the driving apparatus 121 of the extension/contraction part 120.

The operation controller 161 may control the movement of the autonomous mobile robot 10 by performing a known control such as a feedback control or a robust control based on, for example, rotation information of the driving wheels 112 detected by rotation sensors provided in the driving wheels 112. Further, the operation controller 161 may autonomously move the autonomous mobile robot 10 by controlling the moving part 110 based on information such as distance information detected by a camera provided in the autonomous mobile robot 10 or a distance sensor such as an ultrasonic sensor, or map information of the movement environment. Note that the sensor 140 for detecting the marker 91 may be used to sense the movement environment when the autonomous mobile robot 10 moves.

Further, the operation controller 161 determines a support position of the target object 90 based on the position of the marker 91 specified by the marker position specifying unit 160. In this embodiment, the operation controller 161 sets the position of the marker 91 as the support position of the target object 90. Accordingly, for example, the operation controller 161 determines that the position immediately below the center of gravity of the target object 90 is the support position.

Upon determining the support position, the operation controller 161 performs control so as to support the target object 90 by the supporting part 130. That is, upon determining the support position, the operation controller 161 moves the autonomous mobile robot 10 so that the supporting part 130 supports the target object 90 at the support position. Specifically, the operation controller 161 moves the autonomous mobile robot 10 in such a way that, for example, the center part of the supporting part 130 is positioned just below the marker 91. The operation controller 161 then raises the supporting part 130. Accordingly, the supporting part 130 supports and lifts the target object 90 at the determined support position. After that, the operation controller 161 moves the autonomous mobile robot 10 to a transportation destination specified in advance along with the target object 90. Lastly, the operation controller 161 lowers the supporting part 130 and puts the target object 90 on the floor surface at the specified transportation destination (transportation destination point). The transportation is thus completed. The movement of the autonomous mobile robot 10 may not be performed during the transportation by the autonomous mobile robot 10. When, for example, a target object 90 (e.g., a chair) can be connected to another object (e.g., a table) that is present above the target object 90, that is, when it is possible to hang the target object 90 on this object, the transportation may be completed only by raising or lowering the supporting part 130.

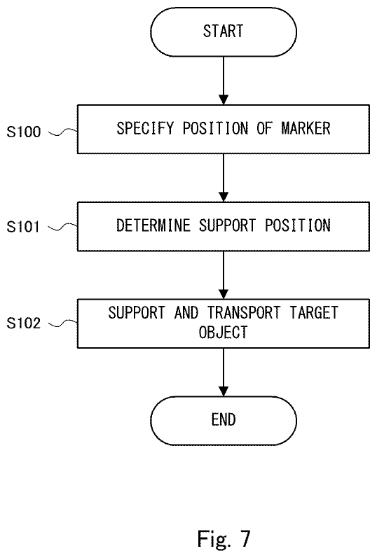

FIG. 7 is a flowchart showing one example of a flow of processing of the transport operation by the autonomous mobile robot 10 according to this embodiment. Hereinafter, with reference to the flowchart, a flow of processing will be described.

In Step S100, the marker position specifying unit 160 specifies the position of the marker 91 attached to the target object 90 based on data from the sensor 140.

Next, in Step S101, the operation controller 161 determines the support position of the target object 90 based on the position of the marker specified in Step S100. In this embodiment, the operation controller 161 sets the position of the marker 91 as the support position of the target object 90.

Next, in Step S102, the operation controller 161 controls the movement of the autonomous mobile robot 10 and the height of the supporting part 130 so as to support the target object 90 at the support position determined in Step S101. Then the operation controller 161 performs control to transport the target object 90 to the specified transportation destination.

The first embodiment has been described above. In this embodiment, the support position of the target object 90 is determined based on the position of the marker 91 attached to the target object. Therefore, an appropriate support position can be selected when the target object is supported and lifted by the autonomous mobile robot 10. That is, it is possible to support the target object 90 while maintaining the balance of the target object 90. In particular, in this embodiment, the position of the marker 91 is the support position of the target object 90. Therefore, it is possible to easily specify the support position.

### Second Embodiment

Next, a second embodiment will be described. In the first embodiment, the marker 91 is preliminarily attached to a position to be supported on a surface of the target object 90. On the other hand, in this embodiment, the marker 91 is attached to a desired position on a surface of the target object 90 in advance. Then the marker 91 used in this embodiment stores information indicating a relative position of a predetermined position of the target object 90 from the position of the marker 91. The predetermined position is a position to be supported specified in advance, like in the first embodiment. That is, the predetermined position is, for example, a position just below the center of gravity of the target object 90. Specifically, the aforementioned relative position may be, for example, coordinate values of the aforementioned predetermined position based on the position to which the marker 91 is attached. The information that indicates the relative position and is stored in the marker 91 may be relative position information (relative position itself) or may be information indicating the source from which the relative position information is acquired (e.g., Uniform Resource Locator (URL)).

The marker 91 may be any medium capable of storing information, and may be, for example, a barcode, a two-dimensional code such as a QR code (registered trademark), or a Radio Frequency (RF) tag. In this embodiment as well, the marker 91 may be an invisible marker so as not to spoil the design of the target object 90.

The autonomous mobile robot 10 according to the second embodiment is different from the autonomous mobile robot 10 according to the first embodiment in that the autonomous mobile robot 10 according to the second embodiment includes a control apparatus 100a in place of the control apparatus 100. While the hardware configuration of the control apparatus 100a is similar to that of the control apparatus 100, the functional configuration of the control apparatus 100a is different from that of the control apparatus 100. The other configurations of the autonomous mobile robot 10 according to the second embodiment are similar to those of the first embodiment. Therefore, in the following description, the descriptions already given above are omitted as appropriate.

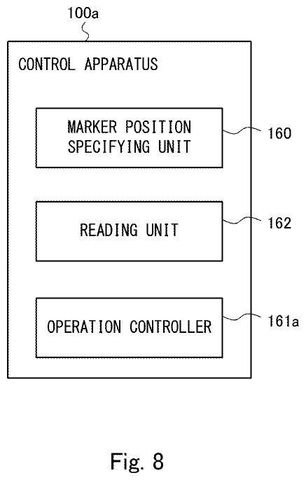

FIG. 8 is a block diagram showing one example of a functional configuration of the control apparatus 100a of the autonomous mobile robot 10 according to the second embodiment. As shown in FIG. 8, the control apparatus 100a includes a marker position specifying unit 160, a reading unit 162, and an operation controller 161a. The marker position specifying unit 160 shown in FIG. 8 is the same as the marker position specifying unit 160 described in the first embodiment. The processing of the components shown in FIG. 8 is achieved by, for example, the processor 101 loading software (computer program) from the memory 102 and executing the loaded software (computer program).

The reading unit 162 performs processing of reading out information that indicates a relative position and is stored in the marker 91. When, for example, the marker 91 is a barcode or a two-dimensional code, the reading unit 162 reads out information indicating the relative position by performing image recognition processing on image data output from the sensor 140. Further, when, for example, the marker 91 is an RF tag, the reading unit 162 performs radio communication processing with the RF tag via the radio communication unit 150, thereby reading out information indicating the relative position.

The operation controller 161a is similar to the operation controller 161 described in the first embodiment except for a method of determining a support position. The operation controller 161a according to this embodiment determines the support position as follows. The operation controller 161a specifies the aforementioned predetermined position of the target object 90 based on the information that indicates the relative position and is read out from the reading unit 162. Then the operation controller 161a sets the predetermined position that has been specified as the support position of the target object 90. When the information indicating the relative position is information indicating the source from which the relative position information is acquired (e.g., URL), the operation controller 161a specifies the aforementioned predetermined position after accessing the source specified by the information indicating the source from which the relative position information is acquired and acquiring the relative position.

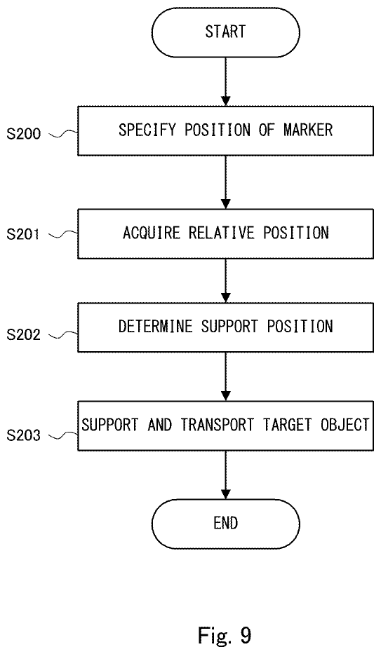

FIG. 9 is a flowchart showing one example of a flow of processing of a transport operation by the autonomous mobile robot 10 according to the second embodiment. Hereinafter, with reference to the flowchart, a flow of processing will be described.

In Step S200, the marker position specifying unit 160 specifies the position of the marker 91 attached to the target object 90 based on data from the sensor 140.

Next, in Step S201, the reading unit 162 reads out information that indicates the relative position and is stored in the marker 91. Accordingly, the operation controller 161a acquires the relative position of the predetermined position of the target object 90 from the position of the marker 91.

Next, in Step S202, the operation controller 161a sets the position specified by the relative position acquired in Step S201 as the support position of the target object 90.

Next, in Step S203, the operation controller 161a controls the movement of the autonomous mobile robot 10 and the height of the supporting part 130 so that the target object 90 is supported at the support position determined in Step S202. Then the operation controller 161a performs control so that the target object 90 is transported to the specified transportation destination.

The second embodiment has been described above. In this embodiment, the support position is determined based on the position of the marker 91 and the relative position obtained from the information stored in the marker 91. Therefore, it is possible to not only select an appropriate support position when the autonomous mobile robot 10 supports and lifts the target object but also attach the marker 91 to a desired position. Therefore, for example, it is possible to attach the marker 91 to a position that can be easily detected by the autonomous mobile robot 10.

### Third Embodiment

Next, a third embodiment will be described. This embodiment is different from the second embodiment in that the marker 91 stores information indicating an ability of the autonomous mobile robot 10 required to transport the target object 90. Note that the information indicating the ability stored in the marker 91 may be ability information (ability itself) or may be information indicating the source from which the ability information is acquired (e.g., URL). The required ability may be, for example, a supporting force of the supporting part 130 that is required to support the target object 90. This is because in order to support the target object 90, a supporting force with which it is capable of supporting a weight that is equal to or larger than the weight of the target object 90 is required. As a required supporting force, a reference value (e.g., the weight of the target object 90) that a maximum value of the weight that can be supported by the autonomous mobile robot 10 should satisfy may be used. Further, the required ability may be, for example, the size of the autonomous mobile robot 10. This is because it is required for the autonomous mobile robot 10 to enter the space under the target object 90 in order to support the target object 90.

In this embodiment as well, the marker 91 may be any medium that can store information, and may be, for example, a barcode, a two-dimensional code, or an RF tag. Further, the marker 91 may be an invisible marker so as not to spoil the design of the target object 90.

The autonomous mobile robot 10 according to the third embodiment is different from the autonomous mobile robot 10 according to the second embodiment in that the autonomous mobile robot 10 according to the third embodiment includes a control apparatus 100b in place of the control apparatus 100a. While the hardware configuration of the control apparatus 100b is similar to that of the control apparatus 100a, the functional configuration of the control apparatus 100b is different from that of the control apparatus 100a. The other configurations of the autonomous mobile robot 10 according to the third embodiment are similar to those of the second embodiment. Therefore, in the following description, the descriptions already given above are omitted as appropriate.

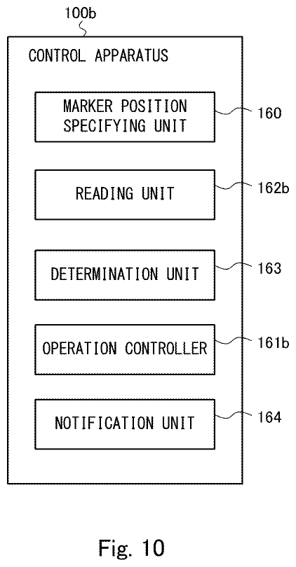

FIG. 10 is a block diagram showing one example of a functional configuration of the control apparatus 100b of the autonomous mobile robot 10 according to the third embodiment. As shown in FIG. 10, the control apparatus 100b includes a marker position specifying unit 160, a reading unit 162b, a determination unit 163, an operation controller 161b, and a notification unit 164. The marker position specifying unit 160 shown in FIG. 10 is the same as the marker position specifying unit 160 described in the first embodiment. The processing of the components shown in FIG. 10 is achieved by, for example, the processor 101 loading software (computer program) from the memory 102 and executing the loaded software (computer program).

The reading unit 162b performs processing of reading out information stored in the marker 91. In particular, the reading unit 162b performs processing of reading out information that indicates the ability of the autonomous mobile robot 10 required to transport the target object 90 and is stored in the marker 91. When, for example, the marker 91 is a barcode or a two-dimensional code, the reading unit 162b performs image recognition processing on image data output from the sensor 140, thereby reading out the information indicating the ability. Further, when, for example, the marker 91 is an RF tag, the reading unit 162b reads out information indicating the ability by performing radio communication processing with the RF tag via the radio communication unit 150.

The determination unit 163 determines, based on the information indicating the ability of the autonomous mobile robot 10 required to transport the target object 90, whether or not to transport the target object 90. The determination unit 163 compares, for example, the actual ability of the autonomous mobile robot 10 specified from the ability information stored in the memory 102 in advance with the required ability and determines that it is possible to transport the target object 90 when the actual ability is equal to or higher than the required ability. That is, the determination unit 163 determines to transport this target object 90. On the other hand, when the actual ability is lower than the required ability, the determination unit 163 determines that it is impossible to transport this target object 90. That is, the determination unit 163 determines not to transport this target object 90.

The notification unit 164 sends a notification for requesting an autonomous mobile robot having an ability specified from the information indicating the required ability to transport the target object 90. The notification unit 164 sends this notification via the radio communication unit 150. When the determination unit 163 has determined that the autonomous mobile robot 10 will not transport the target object 90, the notification unit 164 sends a notification to request another autonomous mobile robot to transport the target object 90. At this time, the notification unit 164 refers to, for example, ability information of another autonomous mobile robot stored in advance in the memory 102 or the like, and specifies another autonomous mobile robot having the required ability.

The operation controller 161b is different from that of the second embodiment in that the operation controller 161b executes control for transportation in accordance with the result of the determination made by the determination unit 163. That is, in this embodiment, when the determination unit 163 has determined to transport this target object 90, the operation controller 161b executes control for transporting this target object 90. On the other hand, when the determination unit 163 has determined not to transport the target object 90, the operation controller 161b does not execute the control for transporting the target object 90.

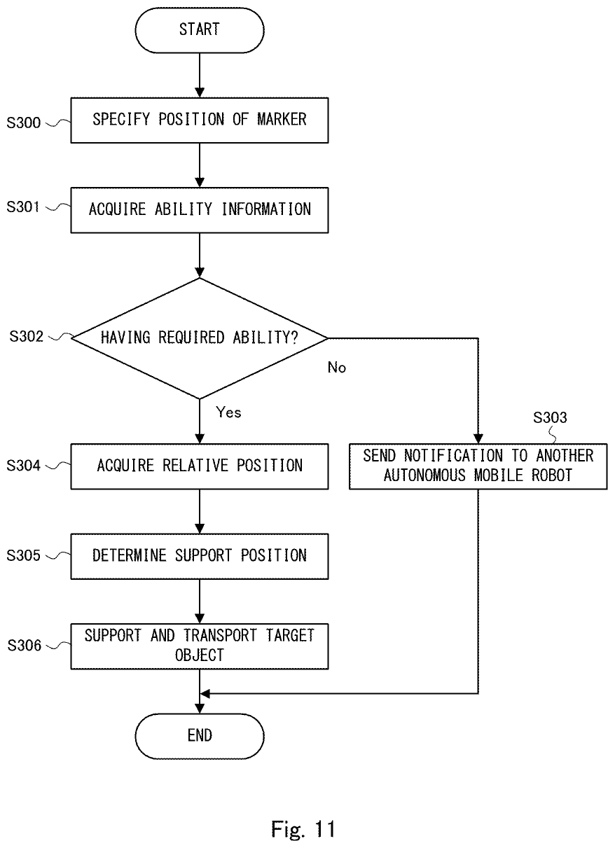

FIG. 11 is a flowchart showing one example of a flow of processing of a transport operation by the autonomous mobile robot 10 according to the third embodiment. Hereinafter, with reference to the flowchart, a flow of processing will be described.

In Step S300, the marker position specifying unit 160 specifies the position of the marker 91 attached to the target object 90 based on data from the sensor 140.

Next, in Step S301, the reading unit 162b reads out information that indicates the ability of the autonomous mobile robot 10 required to transport the target object 90 and is stored in the marker 91. Accordingly, the determination unit 163 acquires the ability information regarding the required ability in order to transport the target object 90.

Next, in Step S302, the determination unit 163 compares the ability information acquired in Step S301 with the ability information regarding the ability that the autonomous mobile robot 10 actually has and determines whether or not the autonomous mobile robot 10 has the required ability. When the autonomous mobile robot 10 does not have the required ability, the determination unit 163 determines not to transport the target object 90, and the processing proceeds to Step S303. On the other hand, when the autonomous mobile robot 10 has the required ability, the determination unit 163 determines to transport this target object 90, and the processing proceeds to Step S304. In this case, processing from Steps S304 to S306 is performed.

In Step S303, the notification unit 164 sends a notification to request another autonomous mobile robot to transport the target object 90. Then the processing ends.

On the other hand, in Step S304, the reading unit 162b reads out information that indicates the relative position and is stored in the marker 91. Accordingly, the operation controller 161b acquires the relative position of the predetermined position of the target object 90 from the position of the marker 91.

Next, in Step S305, the operation controller 161b sets the position specified by the relative position acquired in Step S304 as the support position of the target object 90.

Next, in Step S306, the operation controller 161b controls the movement of the autonomous mobile robot 10 and the height of the supporting part 130 so as to support the target object 90 at the support position determined in Step S305. Then the operation controller 161b performs control so as to transport the target object 90 to the specified transportation destination.

The third embodiment has been described above. In this embodiment, information indicating the ability of the autonomous mobile robot 10 required to transport the target object 90 is stored in the marker 91, whereby it is possible to determine whether or not the autonomous mobile robot 10 is able to support the target object 90. It is therefore possible to prevent an autonomous mobile robot 10 that does not have an ability sufficient to support the target object 90 from supporting the target object 90. Further, in particular, the notification unit 164 sends a notification of requesting the autonomous mobile robot having the required ability to transport the target object 90. Accordingly, it is possible to achieve transportation by an appropriate autonomous mobile robot.

While the operation controller 161b sets the position specified by the relative position as the support position of the target object 90 in this embodiment, like in the second embodiment, the operation controller 161b may set the position of the marker 91 as the support position of the target object 90, like in the first embodiment. In this case, processing of reading out the information that indicates the relative position and is stored in the marker 91, the processing being performed by the reading unit 162b, is omitted.

### Fourth Embodiment

Next, a fourth embodiment will be described. This embodiment is different from the second embodiment in that the orientation of the autonomous mobile robot 10 with respect to the target object 90 is adjusted when support of the target object 90 is started.

Further, in this embodiment, the marker 91 stores information indicating the position of a predetermined part of the target object 90. The predetermined part may be any part of the surface of the target object 90 and may be, for example, the front part of the target object 90, which is furniture. The position of the predetermined part is a position specified in advance. Specifically, the position of the predetermined part is, for example, a relative position of the position of a predetermined part from the position of the marker 91. For example, the position of the predetermined part may be coordinate values of the position of a predetermined part based on the position to which the marker 91 is attached. The information that indicates the position of the predetermined part and is stored in the marker 91 may be information on the position of the predetermined part (the position itself) or information indicating the source from which the information on the position of the predetermined part is acquired (e.g., URL).

In this embodiment as well, the marker 91 may be any medium capable of storing information, and may be, for example, a barcode, a two-dimensional code, or an RF tag. Further, the marker 91 may be an invisible marker so as not to spoil the design of the target object 90.

The autonomous mobile robot 10 according to the fourth embodiment is different from the autonomous mobile robot 10 according to the second embodiment in that the autonomous mobile robot 10 according to the fourth embodiment includes a control apparatus 100c in place of the control apparatus 100a. While the hardware configuration of the control apparatus 100c is similar to that of the control apparatus 100a, the functional configuration of the control apparatus 100c is different from that of the control apparatus 100a. The other configurations of the autonomous mobile robot 10 according to the fourth embodiment are similar to those of the second embodiment. Therefore, in the following description, the descriptions already given above are omitted as appropriate.

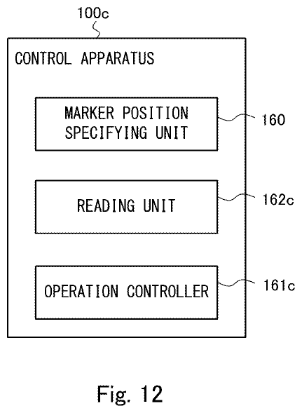

FIG. 12 is a block diagram showing one example of a functional configuration of the control apparatus 100c of the autonomous mobile robot 10 according to the fourth embodiment. As shown in FIG. 12, the control apparatus 100c includes a marker position specifying unit 160, a reading unit 162c, and an operation controller 161c. The marker position specifying unit 160 shown in FIG. 12 is the same as the marker position specifying unit 160 described in the first embodiment. The processing of the components shown in FIG. 12 is achieved by, for example, the processor 101 loading software (computer program) from the memory 102 and executing the loaded software (computer program).

The reading unit 162c performs processing of reading out information stored in the marker 91. In particular, the reading unit 162c performs processing of reading out information that indicates the position of the predetermined part of the target object 90 and is stored in the marker 91. When, for example, the marker 91 is a barcode or a two-dimensional code, the reading unit 162c performs image recognition processing on image data output from the sensor 140, thereby reading out the information indicating the position of the predetermined part. Further, when, for example, the marker 91 is an RF tag, the reading unit 162c reads out the information indicating the position of the predetermined part by performing radio communication processing with the RF tag via the radio communication unit 150.

The operation controller 161c is different from that in the second embodiment in that the operation controller 161c executes control of adjusting the orientation of the autonomous mobile robot 10 when the supporting operation is started.

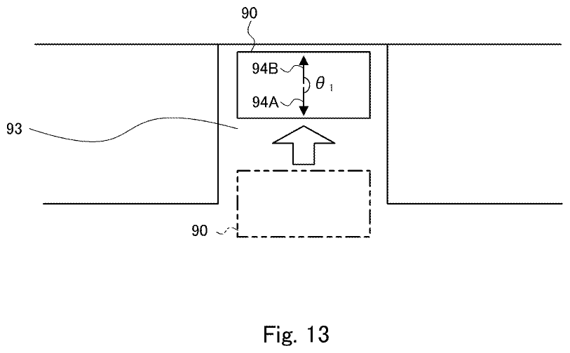

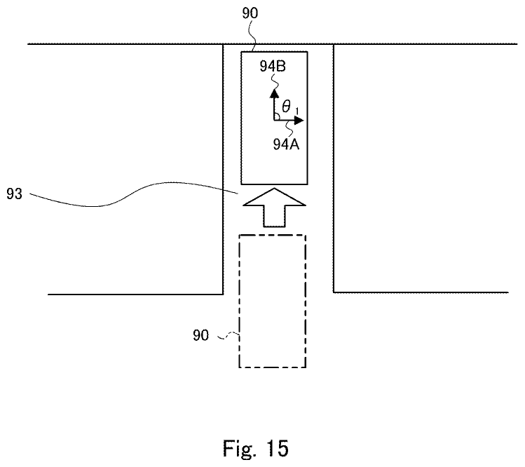

FIGS. 13 and 15 are plan views each showing an example of an environment in which transportation is conducted. In the examples shown in FIGS. 13 and 15, the final transportation destination of the target object 90 is the back of a gap 93. Therefore, the autonomous mobile robot 10 enters the gap 93 and reaches the transportation destination while keeping the target object 90 to be lifted. At this time, it is difficult to rotate the target object 90 at the transportation destination. Therefore, in some examples, when the target object 90 is made to enter the gap 93, the direction of the target object 90 matches the direction required for the target object 90 at the transportation destination point. When, for example, it is desired to arrange the target object 90, which is furniture, in such a way that the front part thereof is facing the exit side of the gap 93, it is required that the autonomous mobile robot 10 travel along the gap in a state in which the front of the target object 90 is facing the exit side. That is, it is required that the orientation of the autonomous mobile robot 10 with respect to the target object 90 be appropriate. On the other hand, when the orientation of the autonomous mobile robot 10 with respect to the target object 90 is not appropriate, the autonomous mobile robot 10 needs to stop, for example, lifting the target object 90 in the middle of the transportation, correct the orientation of the autonomous mobile robot 10 with respect to the target object 90, lift the target object 90 again, and continue the transportation. That is, in this case, the transportation is interrupted, which causes the efficiency of the transportation to be reduced.

In this embodiment, in order to solve the above problem, the operation controller 161c adjusts the orientation of the autonomous mobile robot 10 when the supporting operation is started in such a way that the angle between the direction required for the target object 90 at the transportation destination point and the traveling direction of the autonomous mobile robot 10 at the time of final traveling to the transportation destination point (this angle will be referred to as a first angle) becomes equal to the angle between the direction of the target object 90 when the transportation is started and the direction of the forward traveling or backward traveling of the autonomous mobile robot 10 when the transportation is started (this angle will be referred to as a second angle). The term “direction” is a direction in the horizontal direction, that is, a direction on a horizontal plane. The direction of the target object 90 is a direction in which a predetermined part (e.g., front part) of the target object 90 is facing. Further, the final traveling to the transportation destination point means the final linear traveling of the autonomous mobile robot 10 conducted to reach the transportation destination point. More specifically, when the final traveling is forward traveling, the aforementioned second angle is the angle between the direction of the target object 90 when the transportation is started and the forward traveling direction of the autonomous mobile robot 10 when the transportation is started. Further, when the final traveling is backward traveling, the aforementioned second angle is the angle between the direction of the target object 90 when the transportation is started and the backward traveling direction of the autonomous mobile robot 10 when the transportation is started. Whether the final traveling is forward traveling or backward traveling is determined based on, for example, route information for specifying a transport route.

The operation controller 161c specifies the direction required for the target object 90 at the transportation destination point based on, for example, arrangement information for specifying the orientation at the transportation destination point of the target object 90. Further, the operation controller 161c specifies the traveling direction of the autonomous mobile robot 10 at the time of final traveling to the transportation destination point based on, for example, route information for specifying the transport route. Accordingly, the operation controller 161c calculates the first angle from these directions.

Further, the operation controller 161c specifies the direction of the target object 90 when the transportation is started based on the position of the predetermined part of the target object 90 in this embodiment. The traveling direction (forward traveling direction or backward traveling direction) of the autonomous mobile robot 10 is known to the autonomous mobile robot 10. Accordingly, the operation controller 161c calculates the second angle from these directions.

The operation controller 161c adjusts the orientation of the autonomous mobile robot 10 with respect to the target object 90 when the support is started in such a way that the second angle becomes equal to the first angle. Note that the two angles may not be exactly the same and may include a predetermined margin of error that allows two angles to be considered the same.

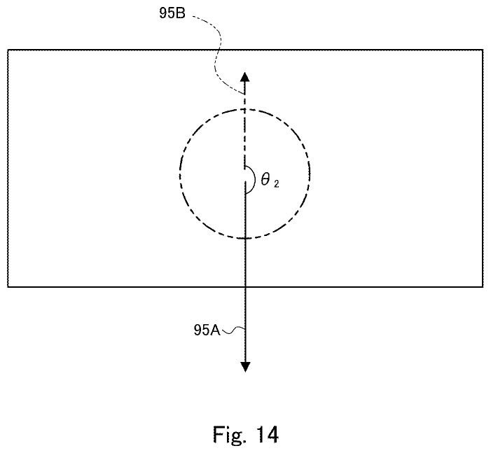

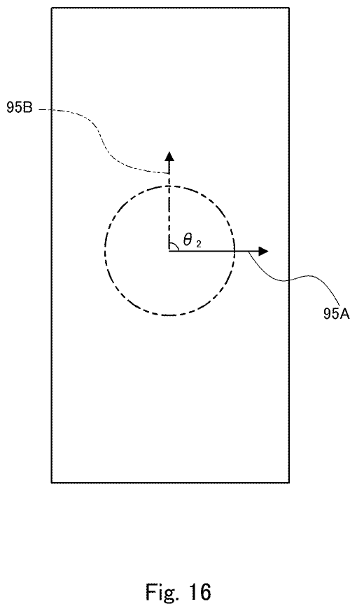

FIG. 14 is a schematic view showing the orientation of the autonomous mobile robot 10 with respect to the target object 90 adjusted at a time of start of the transportation when the transportation as shown in FIG. 13 is conducted. Further, FIG. 16 is a schematic view showing the orientation of the autonomous mobile robot 10 with respect to the target object 90 adjusted at a time of start of the transportation when the transportation as shown in FIG. 15 is conducted. Further, in FIGS. 13 and 15, the arrow 94A indicates the direction required for the target object 90 at the transportation destination point and the arrow 94B indicates the traveling direction of the autonomous mobile robot 10 at the time of final traveling to the transportation destination point. Further, in FIGS. 14 and 16, the arrow 95A indicates the direction of the target object 90 when the transportation is started and the arrow 95B indicates the direction of the forward traveling or backward traveling of the autonomous mobile robot 10 when the transportation is started. When the transportation as shown in FIG. 13 is conducted, the aforementioned first angle θ₁ is 180 degrees. Further, when the transportation as shown in FIG. 15 is conducted, the aforementioned first angle θ₁ is 90 degrees. As shown in FIGS. 14 and 16, the operation controller 161c adjusts the orientation of the autonomous mobile robot 10 with respect to the target object 90 when the support is started in such a way that the second angle θ₂ becomes equal to the first angle θ₁. Accordingly, it is possible to prevent the orientation of the autonomous mobile robot 10 with respect to the target object 90 from being adjusted in the middle of the transportation, whereby the efficiency of the transportation is improved.

Further, the operation controller 161c may adjust the orientation as follows.

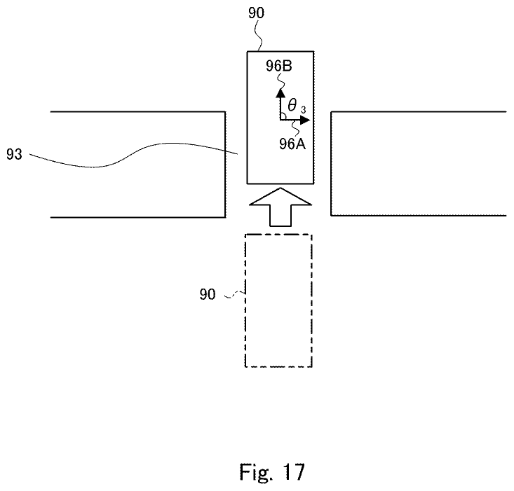

FIG. 17 is a plan view showing an example of an environment in which transportation is conducted. In the example shown in FIG. 17, there is a gap 93 on a transport route of the target object 90 and the width of the gap 93 is narrower than the maximum width of the target object 90. Therefore, in some examples when the autonomous mobile robot 10 that supports the target object 90 passes the gap 93, the direction of the target object 90 matches the direction that is required for the target object 90 to pass. When, for example, the length of the depth of the target object 90 when it is seen from the front is smaller than the width of the gap 93, it is required, for example, that the front of the target object 90 be vertical to the traveling direction in order for the target object 90 to pass the gap 93. That is, it is required that the orientation of the autonomous mobile robot 10 with respect to the target object 90 be appropriate. On the other hand, when the orientation of the autonomous mobile robot 10 with respect to the target object 90 is not appropriate, the autonomous mobile robot 10 needs to stop, for example, lifting the target object 90 in the middle of the transportation, correct the orientation of the autonomous mobile robot 10 with respect to the target object 90, lift the target object 90 again, and continue the transportation. In this case, the transportation is interrupted, which causes the efficiency of the transportation to be reduced.

In order to solve the above problem, the operation controller 161c adjusts the orientation of the autonomous mobile robot 10 when the support is started in such a way that the angle between the direction that is required for the target object 90 to pass the gap on the transport route and the traveling direction of the autonomous mobile robot 10 when it passes the gap (this angle will be referred to as a third angle) becomes equal to the angle between the direction of the target object 90 when the transportation is started and the direction of the forward traveling or backward traveling of the autonomous mobile robot 10 when the transportation is started (this angle is referred to as a fourth angle). The term “direction” is a direction in the horizontal direction, that is, a direction on a horizontal plane. When the passing traveling is forward traveling, the aforementioned fourth angle is, more specifically, the angle between the direction of the target object 90 when the transportation is started and the forward traveling direction of the autonomous mobile robot 10 when the transportation is started. Further, when the passing traveling is backward traveling, the aforementioned fourth angle is the angle between the direction of the target object 90 when the transportation is started and the backward traveling direction of the autonomous mobile robot 10 when the transportation is started. Whether the passing traveling is forward traveling or backward traveling is determined based on, for example, route information for specifying the transport route.

The operation controller 161c specifies the direction required for the target object 90 to pass the gap on the transport route based on, for example, the dimension of the target object 90 and map information including information on the width of the gap. The dimension may be stored in the marker 91 or may be acquired from another apparatus such as a server. The dimension of the target object 90 includes, for example, the width and the depth of the target object 90 when it is seen from the direction in which the aforementioned predetermined part (e.g., front part) of the target object 90 is facing. In this case, when, for example, the depth of the target object 90 is smaller than the width of the gap, the operation controller 161c sets the direction of the target object 90 in which a predetermined part faces the width direction of the gap as the direction required for the target object 90. Further, when, for example, the width of the target object 90 is smaller than the width of the gap, the operation controller 161c sets the direction of the target object 90 in which a predetermined part faces the direction of the passage of the gap as the direction required for the target object 90. Further, the operation controller 161c specifies the traveling direction of the autonomous mobile robot 10 when it passes the gap based on, for example, the route information for specifying the transport route. Accordingly, the operation controller 161c calculates the third angle from these directions.

Further, the operation controller 161c specifies the direction of the target object 90 when the transportation is started based on the position of the predetermined part of the target object 90 in this embodiment. The traveling direction (forward traveling direction or backward traveling direction) of the autonomous mobile robot 10 is known for the autonomous mobile robot 10. Accordingly, the operation controller 161c calculates the fourth angle from these directions.

Then the operation controller 161c adjusts the orientation of the autonomous mobile robot 10 with respect to the target object 90 when the support is started in such a way that the fourth angle becomes equal to the third angle. Note that the two angles may not be exactly the same and may include a predetermined margin of error that allows two angles to be considered the same.

In FIG. 17, the arrow 96A indicates the direction required for the target object 90 to pass the gap 93 on the transport route and the arrow 96B indicates the traveling direction of the autonomous mobile robot 10 when it passes the gap 93. When the transportation as shown in FIG. 17 is conducted, the operation controller 161c adjusts the orientation of the autonomous mobile robot 10 with respect to the target object 90 when the support is started in such a way that the fourth angle becomes equal to the third angle θ₃. According to the above structure, it is possible to prevent the orientation of the autonomous mobile robot 10 with respect to the target object 90 from being adjusted in the middle of the transportation, whereby the efficiency of the transportation is improved.

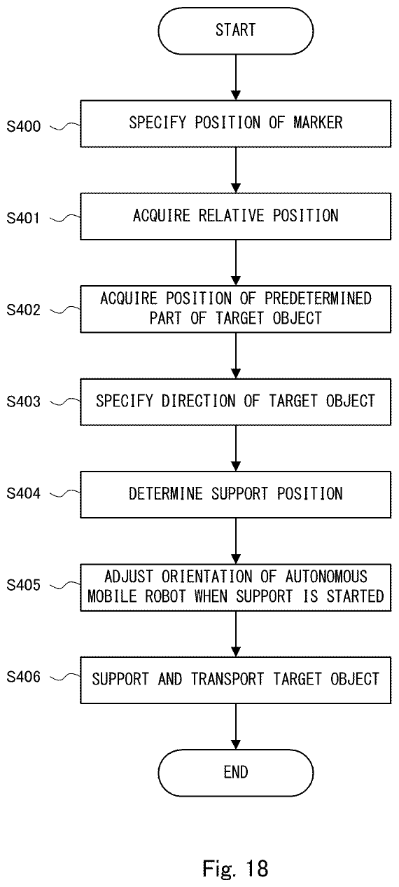

FIG. 18 is a flowchart showing one example of a flow of processing of a transport operation by the autonomous mobile robot 10 according to the fourth embodiment. Hereinafter, with reference to the flowchart, a flow of processing will be described.

In Step S400, the marker position specifying unit 160 specifies the position of the marker 91 attached to the target object 90 based on data from the sensor 140.

Next, in Step S401, the reading unit 162c reads out information that indicates the relative position and is stored in the marker 91. Accordingly, the operation controller 161c acquires the relative position of a predetermined position (e.g., the position just below the center of gravity) of the target object 90 from the position of the marker 91.

Next, in Step S402, the reading unit 162c reads out information that indicates the position of the predetermined part (e.g., front part) of the target object 90 and is stored in the marker 91. Accordingly, the operation controller 161c acquires the position of the predetermined part.

Next, in Step S403, the operation controller 161c specifies the current direction of the target object 90 (i.e., the direction in which a predetermined part of the target object 90 is facing) from the position of the predetermined part acquired in Step S402. In this manner, in this embodiment, the operation controller 161 specifies the direction of the target object 90 based on the information that indicates the position of the predetermined part and is stored in the marker 91. Therefore, it is possible to easily specify the direction of the target object 90 without performing processing such as image recognition processing for specifying the direction of the target object 90. Note that the operation controller 161c may specify the direction of the target object 90 by analyzing images of the target object 90 by image recognition processing. In this case, the marker 91 does not need to store information indicating the position of the predetermined part of the target object 90. Therefore, the aforementioned processing of reading out information is omitted.

Next, in Step S404, the operation controller 161c sets the position specified by the relative position acquired in Step S401 as the support position of the target object 90.

Next, in Step S405, the operation controller 161c adjusts the orientation of the autonomous mobile robot 10 with respect to the target object 90 when the support is started.

Next, in Step S406, the operation controller 161c controls the movement of the autonomous mobile robot 10 and the height of the supporting part 130 so as to support the target object 90 at the support position determined in Step S404. Then the operation controller 161c performs control so as to transport the target object 90 to the specified transportation destination.

The fourth embodiment has been described above. In this embodiment, the orientation of the autonomous mobile robot 10 with respect to the target object 90 when the support is started is adjusted in such a way that the first angle (third angle) becomes equal to the second angle (fourth angle) described above. Therefore, it is possible to prevent the orientation of the autonomous mobile robot 10 with respect to the target object 90 from being adjusted in the middle of the transportation, whereby the efficiency of the transportation is improved.

When the marker 91 is attached to the aforementioned predetermined part, the direction of the target object 90, that is, the direction that a predetermined part of the target object 90 is facing, can be specified by specifying the position of the marker 91. Accordingly, in this case, the marker 91 may not store the information indicating the position of the predetermined part of the target object 90. In this case, the processing of reading out this information by the reading unit 162c is omitted.

Further, while the operation controller 161c sets the position specified by the relative position as the support position of the target object 90 in this embodiment, like in the second embodiment, the operation controller 161c may set the position of the marker 91 as the support position of the target object 90, like in the first embodiment. In this case, the processing of reading out the information that indicates the relative position and is stored in the marker 91, which is performed by the reading unit 162c, is omitted.

Further, the features of this embodiment may be combined with the features of the third embodiment.

### Fifth Embodiment

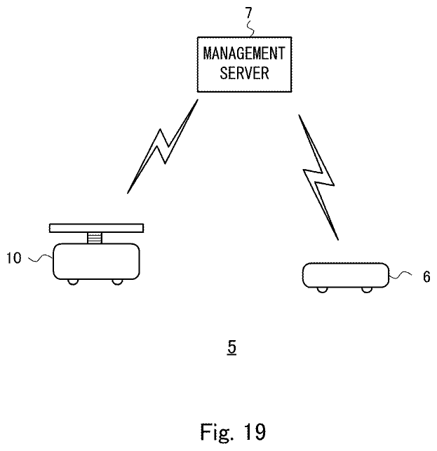

Next, a fifth embodiment will be described. An autonomous mobile robot 10 according to the fifth embodiment is different from that of the second embodiment in that the autonomous mobile robot 10 according to the fifth embodiment assists movement of another autonomous mobile robot. FIG. 19 is a schematic view showing one example of a configuration of a transport system 5 according to the fifth embodiment. As shown in FIG. 19, the transport system 5 includes an autonomous mobile robot 10 that transports a target object 90, another autonomous mobile robot 6, and a management server 7. The autonomous mobile robot 6 is an autonomous mobile robot that performs a predetermined operation such as cleaning of a floor surface that requires movement. The management server 7 is a server that manages the schedule of an operation of the autonomous mobile robot 6 and a moving range at the time of the operation and provides information that is necessary for processing for the autonomous mobile robot 10. The management server 7 is connected to the autonomous mobile robot 10 and the autonomous mobile robot 6 in such a way that the management server 7 can communicate with them.

The autonomous mobile robot 10 according to the fifth embodiment is different from the autonomous mobile robot 10 according to the second embodiment in that the autonomous mobile robot 10 according to the fifth embodiment includes a control apparatus 100d in place of the control apparatus 100a. While the hardware configuration of the control apparatus 100d is similar to that of the control apparatus 100a, the functional configuration of the control apparatus 100d is different from that of the control apparatus 100a. Note that the other configurations of the autonomous mobile robot 10 according to the fifth embodiment are similar to those of the second embodiment. Therefore, in the following description, the descriptions already given above are omitted as appropriate.

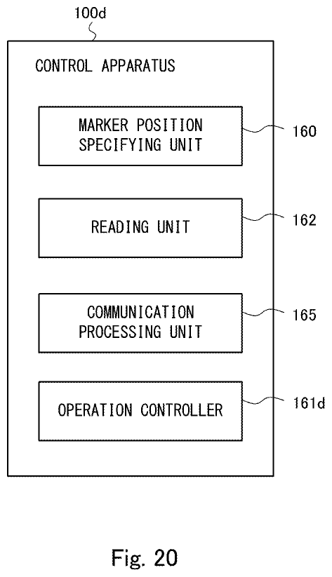

FIG. 20 is a block diagram showing one example of a functional configuration of the control apparatus 100d of the autonomous mobile robot 10 according to the fifth embodiment. As shown in FIG. 20, the control apparatus 100d includes a marker position specifying unit 160, a reading unit 162, a communication processing unit 165, and an operation controller 161d. The marker position specifying unit 160 shown in FIG. 20 is the same as the marker position specifying unit 160 described in the first embodiment. Further, the reading unit 162 shown in FIG. 20 is the same as the reading unit 162 described in the second embodiment. The processing of the components shown in FIG. 20 is achieved, for example, by the processor 101 loading software (computer program) from the memory 102 and executing the loaded software (computer program).

The communication processing unit 165 performs processing of receiving, from the management server 7, a timing when the operation of the autonomous mobile robot 6 is started and a moving range at the time of the operation using the radio communication unit 150. Further, upon completion of transportation by the autonomous mobile robot 10, the communication processing unit 165 notifies the management server 7 of the completion of the transportation.

The operation controller 161d is different from that of the second embodiment in that it performs control for the transportation in accordance with the operation of the autonomous mobile robot 6. That is, in this embodiment, when movement of another autonomous mobile robot 6 is planned, the operation controller 161d performs control so as to support the predetermined target object 90 and move the target object away the moving range of the autonomous mobile robot 6 before the movement of the other autonomous mobile robot 6 is started.

After the communication processing unit 165 receives the timing when the operation of the autonomous mobile robot 6 is started and the moving range at the time of the operation, the operation controller 161d transports a target object 90 that is present in the moving range before the timing when the operation is started, thereby moving the target object 90 away from the moving range of the autonomous mobile robot 6. For example, the operation controller 161d transports the target object 90 to the outside of the moving range. The transportation of the target object 90 in this case may not involve movement of the target object 90 in the horizontal direction. When, for example, the target object 90 (e.g., a chair) can be connected to another object (e.g., a table) that is present above the target object 90, i.e., when it is possible to hang the target object 90 on this object, the transportation of the target object 90 may be performed by movement of the target object 90 in the vertical direction.

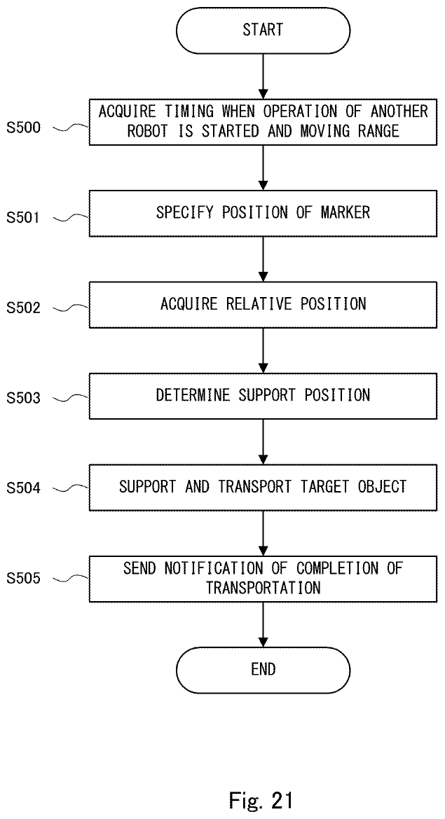

FIG. 21 is a flowchart showing one example of a flow of processing of the transport operation by the autonomous mobile robot 10 according to the fifth embodiment. Hereinafter, with reference to the flowchart, a flow of processing will be described.

In Step S500, the communication processing unit 165 receives the timing when the operation of the autonomous mobile robot 6 is started and the moving range at the time of the operation. Accordingly, the operation controller 161d acquires the timing when the operation of the autonomous mobile robot 6 is started and the moving range at the time of the operation. Then the operation controller 161d starts control for the transportation in such a way that the transportation of the target object 90 that is present in the moving range is carried out before the timing when the operation is started. That is, processing of Step S501 and the subsequent processing are started.

In Step S501, the marker position specifying unit 160 specifies the position of the marker 91 attached to the target object 90 based on data from the sensor 140.

Next, in Step S502, the reading unit 162 reads out information that indicates the relative position and is stored in the marker 91. Accordingly, the operation controller 161d acquires the relative position of the predetermined position of the target object 90 from the position of the marker 91.

Next, in Step S503, the operation controller 161d sets the position specified by the relative position acquired in Step S502 as the support position of the target object 90.

Next, in Step S504, the operation controller 161d controls the movement of the autonomous mobile robot 10 and the height of the supporting part 130 so as to support the target object 90 at the support position determined in Step S503. Then the operation controller 161d performs control to transport the target object 90 to the outside of the moving range of the autonomous mobile robot 6.

When transportation of all the target objects 90 within the moving range of the autonomous mobile robot 6 has been completed, the communication processing unit 165 notifies the management server 7 of the completion of the transportation in Step S505.

The fifth embodiment has been described above. In this embodiment, the target object 90 is moved to the outside of the moving range before the movement of the other autonomous mobile robot 6 is started. It is therefore possible to prevent execution of an operation of the other autonomous mobile robot 6 from being interrupted due to the presence of the target object 90.

While the communication processing unit 165 communicates with the management server 7 in this embodiment, the communication processing unit 165 may communicate with another autonomous mobile robot 6. That is, the communication processing unit 165 may receive the timing when the operation is started and the moving range from the other autonomous mobile robot 6. Then the communication processing unit 165 may notify the other autonomous mobile robot 6 of the completion of the transportation. In this case, the other autonomous mobile robot 6 may start the operation upon receiving this notification.

Further, while the operation controller 161d sets the position specified by the relative position as the support position of the target object 90 in this embodiment, like in the second embodiment, the operation controller 161d may set the position of the marker 91 as the support position of the target object 90, like in the first embodiment. In this case, the processing of reading out the information that indicates the relative position and is stored in the marker 91, the processing being performed by the reading unit 162d, is omitted.

Further, the features of this embodiment may be combined with the features of the third embodiment or the features of the fourth embodiment.

Note that the present disclosure is not limited to the aforementioned embodiments and may be changed as appropriate without departing from the spirit of the present disclosure. For example, in each of the aforementioned embodiments, an Internet of Things (IoT) device including a function of communicating with another apparatus such as the autonomous mobile robot 10 (e.g., RFID, Wi-Fi (registered trademark), Bluetooth (registered trademark) etc.) in addition to a function of storing arbitrary information may be used in place of the marker 91. That is, the autonomous mobile robot 10 may specify the position of a desired reference object (e.g., a marker or an IoT device) attached to the target object 90 and determine the support position of the target object based on the position of the reference object that has been specified. In this case, the marker position specifying unit may be referred to as a reference object position specifying unit.

Further, this reference object may store arbitrary information used to control the moving operation or the supporting operation of the autonomous mobile robot 10. Then the reading unit 162, 162b, 162c, or 162d may read out this information and the operation controller 161, 161a, 161b, 161c, or 161d may control the moving operation or the supporting operation of the autonomous mobile robot 10 using this information. Note that this information may be referred to as operation related information. The operation related information may be, for example, the height of the floating of the target object 90 when it is lifted when the autonomous mobile robot 10 moves while supporting the target object 90, the weight or the size of the target object 90 or the like. According to this structure, the autonomous mobile robot 10 is able to easily achieve the operation based on the operation related information.

Further, the supporting part 130 may include a fitting part such as a protrusion or a groove that fits the target object 90. According to this structure, support stability can be improved. Further, the target object 90 may be a component that composes a piece of furniture by being combined with the supporting part 130. According to this structure, the autonomous mobile robot may be used as furniture. For example, the target object 90 may be a top plate of a table. In this case, the target object 90 is combined with the supporting part 130, whereby the top plate is held at a predetermined height and a table is thus formed.

Further, the supporting part 130 may be connected to the target object 90 not only mechanically but also electrically so that the supporting part 130 communicates with the target object 90 or sends or receives power to or from the target object 90. According to this structure, it is possible to implement various functions that use the electric connection.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A transport system configured to support and transport a target object by an autonomous mobile robot, the transport system comprising:
a reference object position specifying unit configured to specify a position of a reference object attached to the target object; and
an operation controller configured to determine a support position of the target object based on the position of the reference object that has been specified.

2. The transport system according to claim 1, wherein
the reference object is attached to a predetermined position of the target object in advance,
the predetermined position is a position to be supported specified in advance, and
the operation controller sets the position of the reference object as the support position of the target object.

3. The transport system according to claim 1, wherein
the reference object stores information indicating a relative position of a predetermined position of the target object from the position of the reference object,
the predetermined position is a position to be supported specified in advance,
the transport system further includes a reading unit configured to read out the information that indicates the relative position and is stored in the reference object, and
the operation controller specifies the predetermined position of the target object based on the information indicating the relative position and sets the predetermined position as the support position of the target object.

4. The transport system according to claim 1, wherein
the reference object stores operation related information, which is information used to control a moving operation or a supporting operation of the autonomous mobile robot,
the transport system further comprises a reading unit configured to read out the operation related information stored in the reference object, and
the operation controller controls the moving operation or the supporting operation of the autonomous mobile robot using the operation related information.

5. The transport system according to claim 1, wherein
the reference object stores information indicating an ability of the autonomous mobile robot required to transport the target object, and
the transport system further comprises:
a reading unit configured to read out the information that indicates the ability and is stored in the reference object; and
a determination unit configured to determine whether or not to transport the target object based on the information indicating the ability.

6. The transport system according to claim 5, further comprising a notification unit configured to send a notification for asking the autonomous mobile robot having the ability specified by the information indicating the ability to transport the target object.

7. The transport system according to claim 1, wherein the operation controller further adjusts an orientation of the autonomous mobile robot when supporting is started in such a way that an angle between a direction required for the target object at a transportation destination point and a traveling direction of the autonomous mobile robot at a time of final traveling to the transportation destination point becomes equal to an angle between a direction of the target object when transportation is started and a forward traveling direction or a backward traveling direction of the autonomous mobile robot when the transportation is started.

8. The transport system according to claim 1, wherein the operation controller further adjusts an orientation of the autonomous mobile robot when the supporting is started in such a way that an angle between a direction that is required for the target object to pass a gap on a transport route and a traveling direction of the autonomous mobile robot when it passes the gap becomes equal to an angle between a direction of the target object when transportation is started and a forward traveling direction or a backward traveling direction of the autonomous mobile robot when the transportation is started.

9. The transport system according to claim 7, wherein
the reference object stores information indicating the position of a predetermined part of the target object,
the transport system further includes a reading unit configured to read out information that indicates the position of the predetermined part and is stored in the reference object, and
the operation controller specifies the direction of the target object based on the information indicating the position of the predetermined part.

10. The transport system according to claim 1, wherein, when a movement of another autonomous mobile robot is planned, the operation controller performs control so as to support a predetermined target object and move the target object away from a moving range of the other autonomous mobile robot before the movement of the other autonomous mobile robot is started.

11. The transport system according to claim 1, wherein
the autonomous mobile robot comprises a supporting part including a fitting part that fits the target object, and
the operation controller performs control so as to support the target object by the supporting part.

12. The transport system according to claim 11, wherein the target object is a component that forms a piece of furniture by being combined with the supporting part.

13. The transport system according to claim 11, wherein the supporting part is electrically connected to the target object.

14. A transport method for supporting and transporting a target object by an autonomous mobile robot, the transport method comprising:
specifying a position of a reference object attached to the target object; and
determining a support position of the target object based on the position of the reference object that has been specified.

15. A non-transitory computer readable medium storing a program for causing a computer of a transport system configured to support and transport a target object by an autonomous mobile robot to execute:
specifying a position of a reference object attached to the target object; and
determining a support position of the target object based on the position of the reference object that has been specified.
